(19) United States
(12) Patent Application Publication
(10) Pub. No.: US 2025/0162146 A1
(43) Pub. Date: May 22, 2025

(54) Task Sequencing and Deployment for Robot-Assisted Order Fulfillment

(71) Applicant: ZEBRA TECHNOLOGIES CORPORATION, Lincolnshire, IL (US)

(72) Inventors: Uwe Meister, El Dorado, CA (US); Erik Gregory, Hurst, TX (US); Phillip Agans, Stanton, MI (US); Steve Hunt, Port Hueneme, CA (US)

(21) Appl. No.: 18/513,077

(22) Filed: Nov. 17, 2023

(51) Int. Cl. B25J 9/16; G06Q 10/087

(52) U.S. Cl. CPC B25J 9/1661; G06Q 10/087

(57) ABSTRACT

A method in a computing device includes: obtaining a primary sequence including an ordered set of item identifiers and item locations corresponding to the item identifiers; generating a plurality of auxiliary sequences, each auxiliary sequence including a portion of the ordered set of item identifiers and the item locations corresponding to the portion; deploying the primary sequence to a picker for retrieving, from the item locations, items having the item identifiers; and for each auxiliary sequence, deploying the auxiliary sequence to a corresponding one of a plurality of robots, each robot configured to receive the items retrieved at the item locations corresponding to the portion.

### BACKGROUND

Autonomous or semi-autonomous mobile robots can be deployed in facilities such as warehouses, manufacturing facilities, healthcare facilities, or the like, e.g., to transport items within the relevant facility. Items transported by the robots may be retrieved by other entities, such as human pickers, and placed on the robots for transport. The deployment of robots and pickers within the facility may lead to inefficient use of pickers and/or robots.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of item-handing mobile robots deployed in a facility.

FIG. 2 is a diagram of certain components of a mobile robot of FIG. 1.

FIG. 3 is a flowchart illustrating a method of task sequencing and deployment for robot-assisted order fulfillment.

FIG. 4 is a diagram illustrating an example performance of block 305 of the method of FIG. 3.

FIG. 5 is a diagram illustrating an example performance of blocks 310 and 315 of the method of FIG. 3.

FIG. 6 is a diagram illustrating an example performance of blocks 320 and 325 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device including: obtaining a primary sequence including an ordered set of item identifiers and item locations corresponding to the item identifiers; generating a plurality of auxiliary sequences, each auxiliary sequence including a portion of the ordered set of item identifiers and the item locations corresponding to the portion; deploying the primary sequence to a picker for retrieving, from the item locations, items having the item identifiers; and for each auxiliary sequence, deploying the auxiliary sequence to a corresponding one of a plurality of robots, each robot configured to receive the items retrieved at the item locations corresponding to the portion.

Additional examples disclosed herein are directed to a computing device, comprising: a communications interface; and a processor configured to: obtain a primary sequence including an ordered set of item identifiers and item locations corresponding to the item identifiers; generate a plurality of auxiliary sequences, each auxiliary sequence including a portion of the ordered set of item identifiers and the item locations corresponding to the portion; deploy, via the communications interface, the primary sequence to a picker for retrieving, from the item locations, items having the item identifiers; and for each auxiliary sequence, deploy, via the communications interface, the auxiliary sequence to a corresponding one of a plurality of robots, each robot configured to receive the items retrieved at the item locations corresponding to the portion.

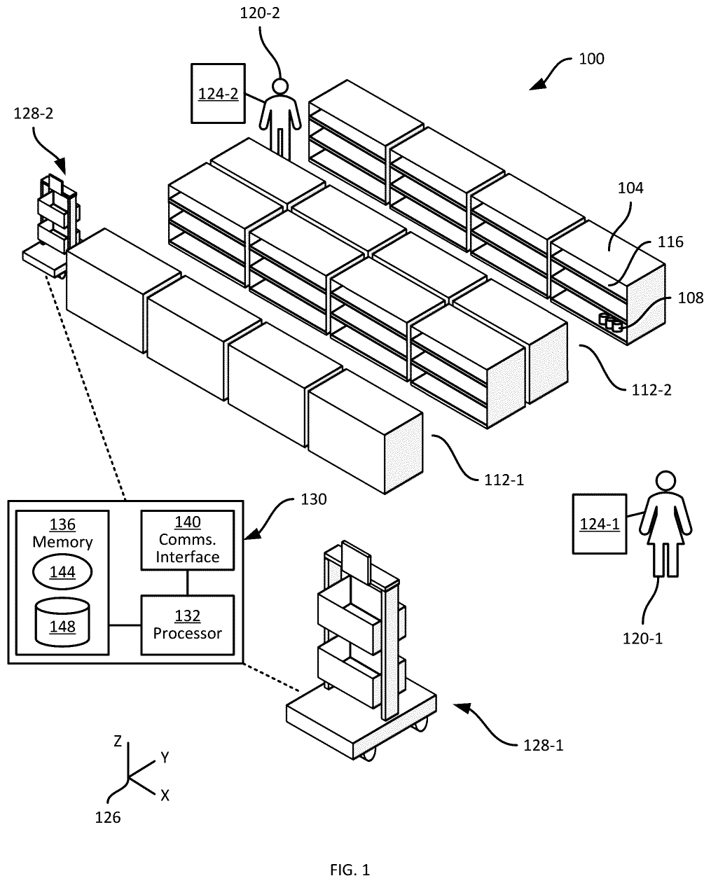

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112-1 and 112-2 (collectively referred to as aisles 112, and generically referred to as an aisle 112; similar nomenclature is used herein for other components with hyphenated reference numbers). As shown in FIG. 1, support structures 104 in the form of shelf modules include support surfaces 116 supporting the items 108. The support structures 104 can also include pegboards, bins, tables, or the like, in other examples. In some examples, the support structures 104 can include portions of a floor of the facility 100, in addition to or instead of distinct structures disposed on the floor, such as the shelf modules shown in FIG. 1.

In other examples, the facility 100 can include fewer aisles 112 than shown, or more aisles 112 than shown in FIG. 1. The aisle 112, in the illustrated example, are formed by sets of eight support structures 104 (four on each side). The facility 100 can also have a wide variety of other aisle layouts, however. As will be apparent, each aisle 112 is a space open at the ends, and bounded on either side by a support structure 104. The aisle 112 can be travelled by humans, vehicles, and the like. In still further examples, the facility 100 need not include aisles 112, and can instead include assembly lines, or the like.

The items 108 may be handled according to a wide variety of processes, depending on the nature of the facility. In the examples discussed below, the facility 100 is a fulfillment facility or the like, and the items 108 disposed on the support structures 104 can be retrieved for shipping from the facility 100 to fulfill incoming orders each indicating identifiers of certain items. The retrieval of an item 108 from a support structure 104 is also referred to as a pick operation. Picks can be performed in the facility 100 by pickers 120-1 and 120-2, such as human workers. Although two pickers 120 are shown in FIG. 1, it will be understood that various numbers of pickers can be deployed in the facility 100, e.g., depending on the size of the facility 100, the rate at which orders are received for fulfillment, and the like. Each picker 120 can operate a client computing device 124-1, 124-2, such as a tablet computer, a smartphone, a wearable computer, or the like. The client devices 124 enable the presentation of information to the pickers 120, as described below in greater detail.

Order fulfillment in the facility 100 can be assisted by mobile robots, of which two example robots 128-1 and 128-2 are shown in FIG. 1. A greater number of robots 128 can be deployed in the facility 100 than the example robots 128 shown in FIG. 1, for example based on the size and/or layout of the facility 100. As will be discussed below, the facility 100 may contain a greater number of robots 128 than pickers 120 in some embodiments.

Each robot 128 is configured to transport items 108, and to travel within the facility 100 autonomously or semi-autonomously. Each robot 128 can be configured to track its pose (e.g., location and orientation) within the facility 100, e.g., within a coordinate system 126 previously established in the facility 100. The robots 128 can navigate autonomously or semi-autonomously within the facility 100, e.g., travelling to assigned locations to receive items 108 retrieved from the support structures 104 by the pickers 120. A picker 120 can retrieve an item 108 from a support structure 104 and deposit the item 108 into or onto a robot 128, in other words. An order can therefore be fulfilled via the picking of each item specified in the order from the support structures 104 by one or more pickers 120, and the placement of the picked items 108 into or onto a given robot 128. The robot 128 can then, for example, travel to a pack-out area of the facility 100 for the items 108 to be removed from the robot 128 and packaged for shipment.

It will be understood that the fulfillment of orders in the facility 100 involves travel to various locations in the facility 100 by the pickers 120 and/or the robots 128, for the pickers 120 to retrieve certain items, and for the robots 128 to collect and transport the items for a given order to a terminal location such as the pack-out area noted above. The locations to which each picker 120 and robot 128 is instructed to travel can be deployed by a computing device such as a server 130. That is, the server 130 can be configured to assign tasks to the pickers 120 and/or the robots 128. A task can include, for example, a location in the facility 100, and an identifier of an item 108, e.g., to be picked and placed to a robot 128 at the location. The task can also include other information, such as a quantity of the item 108, in some examples.

Tasks can be assigned to the pickers 120 and/or robots 128 via the exchange of messages between the server 130 and the client devices 124 and/or the robots 128, e.g., over a suitable combination of local and wide-area networks. The server 130 can be deployed at the facility 100, or remotely from the facility 100. In some examples, the server 130 is configured to assign tasks to pickers 120 and robots 128 at multiple facilities, and need not be physically located in any of the individual facilities.

Tasks can be assigned to pickers 120 and robots 128 according to various models. Models according to which some systems deploy tasks to pickers 120 and robots 128, however, may make inefficient use of the pickers 120 and/or the robots 128.

For example, in some systems a sequence of tasks are assigned to a given picker 120, representing the items 108 in a given order or set of orders. The sequence of tasks can also be referred to as a tour. In such systems, a given robot 128 is assigned to follow the picker 120. That is, the robot 128 is paired with the picker 120 for the duration of the picker's tour. The picker 120 travels within the facility 100 between the locations specified in the sequence of tasks, and at each location, picks the specified item(s) and places them in the robot 128. The above model in which a robot 128 is persistently paired with a picker 120 for a picker tour can, however, reduce the speed at which the picker 120 can travel the facility 100 and retrieve the items 108. For example, the robots 128 may have lower travel speeds than the pickers 120. The robots 128 may also have movement constraints, such as being restricted to travelling along each aisle 112 in a single direction (e.g., being barred from changing directions after entering an aisle 112 from either end). The above model is also subject to the carrying capacity of a robot 128. In other words, once the robot 128 is at its carrying capacity, no further items 108 can be picked to the robot 128.

In other systems, a “swarming” model is implemented, in which the pickers 120 are assigned to zones of the facility 100, such as specific aisles, portions of aisles, or the like. Instead of pickers 120 being assigned tasks forming a tour, a robot 128 is assigned tasks forming a tour. A picker 120 in a given zone awaits the arrival of a robot 128, and upon arrival of the robot at a location within the zone, the picker 120 can retrieve the relevant item(s) 108 for placement to the robot 128. The pickers 120 and robots 128, in other words, are not paired persistently. Instead, pairings between robots 128 and pickers 120 are transient, and may persist for only a single pick operation. Although the swarming model set out above may reduce the time spent travelling by pickers 120, the model may involve significant idle time on the part of pickers 120 in some zones, e.g., when the orders currently under fulfillment do not include items in those zones. Other zones, meanwhile, may become congested with robots 128. Some systems attempt to mitigate idle time and congestion as noted above by optimizing order selection for robot 128 tours, and/or by dynamically re-assigning pickers 120 between zones. However, those mitigation actions can be computationally intensive, and may also be ineffective, depending on the pool of orders to be allocated to the robots 128, available pickers 120, and the like.

The server 130 is configured to implement a model of task assignment distinct from those mentioned above. As discussed herein, the server 130 is configured to deploy tours encompassing one or more orders to pickers 120. Further, for each picker tour, the server 130 is configured to allocate a plurality of the robots 128, with each robot 128 having a tour that partially covers the picker tour. A given picker 120 can therefore travel to any portion of the facility (e.g., without being restricted to a particular zone), while reducing or eliminating the need to wait for a following robot 128, and while also avoiding the capacity constraint of any single robot 128.

The server 130 includes a processor 132, such as one or more central processing units (CPU), graphics processing units (GPU), or dedicated hardware controllers such as application-specific integrated circuits (ASICs). The processor 132 is communicatively coupled with a non-transitory computer readable medium such as a memory 136, e.g., a suitable combination of volatile and non-volatile memory elements. The processor 132 is also coupled with a communications interface 140, such as a transceiver (e.g., an Ethernet controller or the like) enabling the server 130 to communicate with other computing devices, such as the mobile robots 128. The memory 136 can store a plurality of computer-readable instructions executable by the processor 132, such as an application 144 whose execution by the processor 132 configures the processor 132 to deploy task sequences to the pickers 120 and robots 128, e.g., based on incoming orders identifying items 108. The application 144 can implement, for example, a warehouse management system (WMS) configured to receive orders from other computing devices, and generate tasks to be sequenced and deployed to the pickers 120 and robots 128. In other examples, WMS functionality can be implemented by a computing device distinct from the server 130. The memory 136 can also store, in this example, a repository 148 of item identifiers and item locations, e.g., in the coordinate system 126. In other examples, the repository 148 can be stored at another computing device implementing a WMS, as noted above. In some examples, the server 130 can be implemented in a distributed format, e.g., by a cloud computing platform or the like.

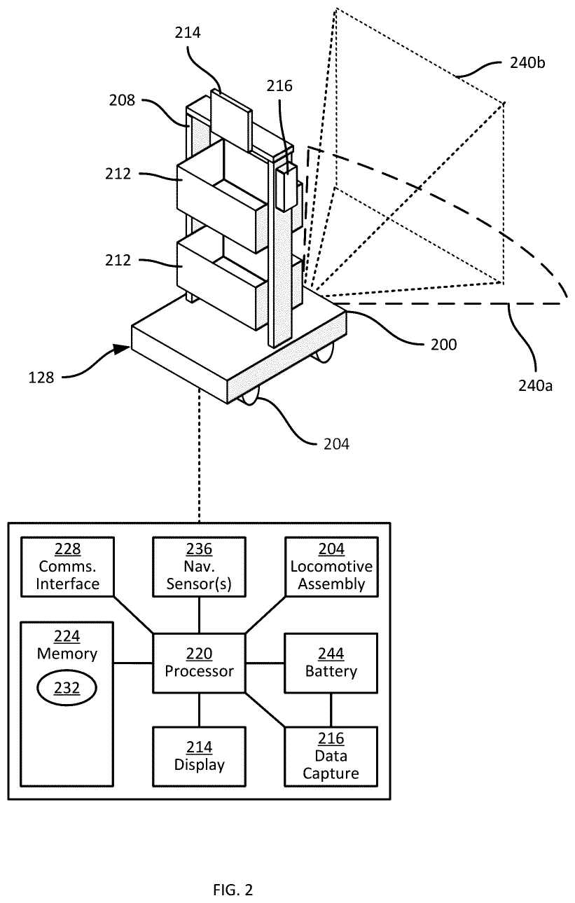

Before discussing the sequencing and deployment of tasks as implemented by the server 130 in greater detail, certain components of the robots 128 are discussed with reference to FIG. 2. As shown in FIG. 2, each robot 128 includes a chassis 200 supporting various other components of the robot 128. In particular, the chassis 200 supports a locomotive assembly 204, such as one or more electric motors driving a set of wheels, tracks, or the like. The locomotive assembly 204 can include one or more sensors such as a wheel odometer, an inertial measurement unit (IMU), and the like.

The chassis 200 also supports receptacles, shelves, or the like, to support items 108 during transport. For example, the robot 128 can include a selectable combination of receptacles 212. In the illustrated example, the chassis 200 supports a rack 208, e.g., including rails or other structural features configured to support receptacles 212 at variable heights above the chassis 200. The receptacles 212 can therefore be installed and removed to and from the rack 208, enabling distinct combinations of receptacles 212 to be supported by the robot 128. For example, a robot 128 can be fitted with one large receptacle 212 in some cases, and later fitted with four smaller receptacles 212, e.g., depending on the number of orders to be fulfilled with the assistance of the robot 128.

The robot 128 can also include an output device, such as a display 214. In the illustrated example, the display 214 is mounted above the rack 208, but it will be apparent that the display 214 can be disposed elsewhere on the robot 128 in other examples. The display 214 can include an integrated touch screen or other input device, in some examples. The robot 128 can also include other output devices in addition to or instead of the display 214. For example, the robot 128 can include one or more speakers, light emitters such as strips of light-emitting diodes (LEDs) along the rack 208, and the like.

The robot 128 can further include a data capture device 216, such as a barcode scanner, radio frequency identification (RFID) reader, or the like. The data capture device 216 can, for example, scan a barcode affixed to an item 108 when the item 108 is placed within a field of view of the data capture device 216. A picker 120 can, for example, pick an item 108 displayed via the corresponding client device 124 and scan the item 108 at the data capture device 216 to transmit a message to the server 130 (e.g., via the robot 128) that the item 108 has been picked and deposited to the robot 128. Such messages can be employed to advance through sequences of pick tasks.

The chassis 200 of the robot 128 also supports various other components, including a processor 220, e.g., one or more CPUs, GPUs, or dedicated hardware controllers such as ASICs. The processor 220 is communicatively coupled with a non-transitory computer readable medium such as a memory 224, e.g., a suitable combination of volatile and non-volatile memory elements. The processor 220 is also coupled with a communications interface 228, such as a wireless transceiver enabling the robot 128 to communicate with other computing devices, such as the server 130, client devices 124, and other robots 128.

The memory 224 stores various data used for autonomous or semi-autonomous navigation, including an application 232 executable by the processor 220 to implement navigational and other task execution functions. In some examples, the above functions can be implemented via multiple distinct applications stored in the memory 224.

The chassis 200 can also support a navigational sensor 236, such as one or more cameras and/or depth sensors (e.g., lidars, depth cameras, time-of-flight cameras, or the like) coupled with the processor 220. The sensor(s) 236 are configured to capture image and/or depth data depicting at least a portion of the physical environment of the robot 128. Data captured by the sensor(s) 236 can by used by the processor 220 for navigational purposes, e.g., path planning, obstacle avoidance, and the like, as well as for updating a map of the facility in some examples.

The sensors 236 have respective fields of view (FOVs). For example, a first FOV 240a corresponds to a laser scanner, such as a lidar sensor disposed on a forward-facing surface of the chassis 200. The FOV 240a can be substantially two-dimensional, e.g., extending forwards in a substantially horizontal plane. A second FOV 240b corresponds to a camera (e.g., a depth camera, a color camera, or the like) also mounted on the forward-facing surface of the chassis 200. As will be apparent, a wide variety of other optical sensors can be disposed on the chassis 200 and/or the rack 208, with respective FOVs 240a and 240b. The FOVs 240 need not be configured exactly as shown in FIG. 2. For example, the FOV 240a can extend over a greater angular range than that illustrated (e.g., over about 270 degrees, in some examples).

The components of the robot 128 that consume electrical power can be supplied with such power from a battery, e.g., implemented as one or more rechargeable batteries housed in the chassis 200.

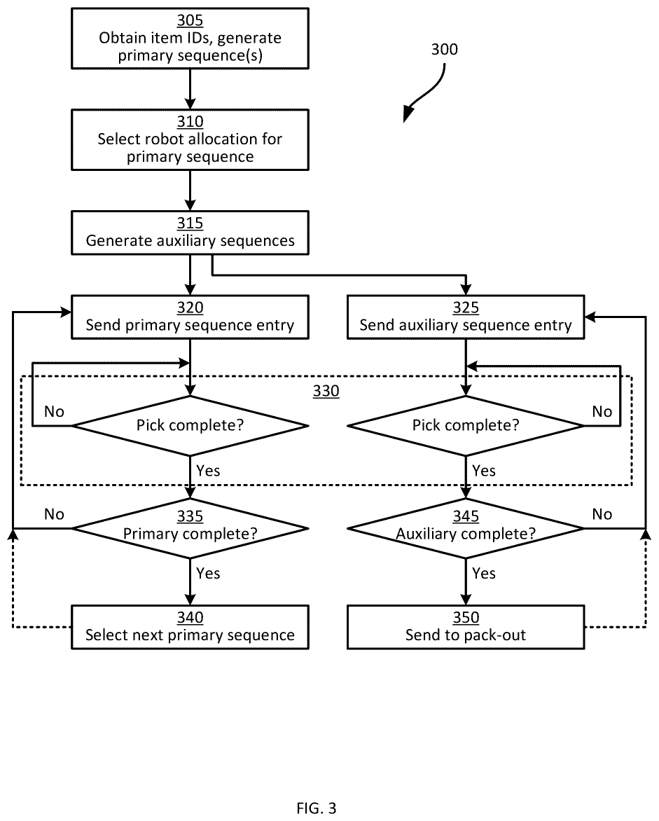

Turning to FIG. 3, a method 300 of task sequencing and deployment in robot-assisted order fulfillment is illustrated. The method 300 is described below in conjunction with its example performance in the facility 100. In particular, the method 300 is described below as performed by the server 130, e.g., via execution of the application 144 by the processor 132.

At block 305, the server 130 is configured to obtain a plurality of item identifiers corresponding to the items 108, and to generate one or more primary task sequences, also referred to as primary sequences. The server 130 can, for example, receive a set of orders record from one or more other computing devices, with each order record containing at least one item identifier, corresponding to an item 108 to be picked to fulfill the order. Each order record can also contain a quantity corresponding to each listed item identifier. Each order record can contain, or otherwise be associated with, other information such as a timestamp indicating the date and time the order was received, a customer identifier, payment information, a customer location, and the like.

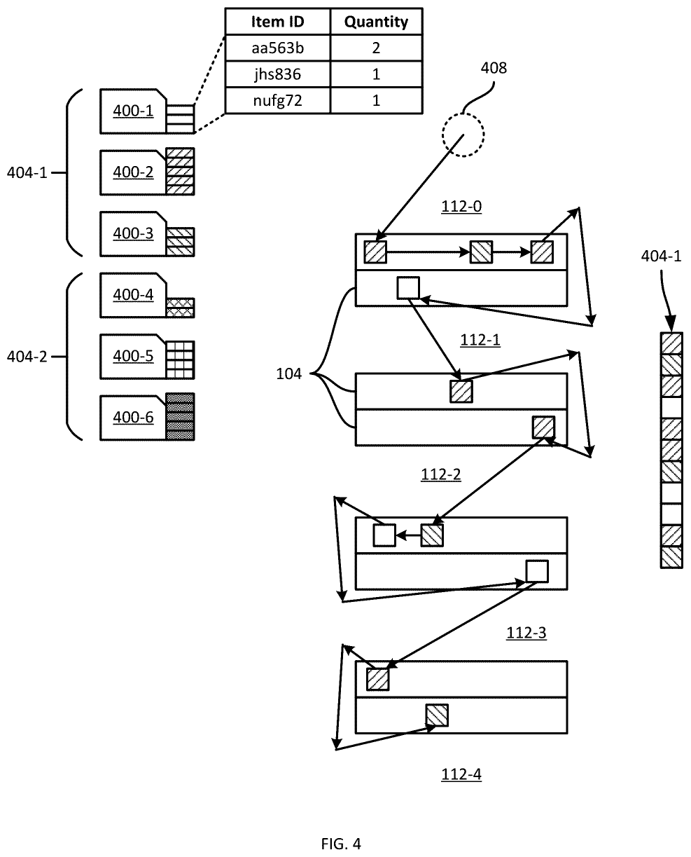

A primary sequence is an ordered set of item identifiers, extracted from one or more order records. The primary sequence, as described below, is deployed to a single selected picker 120, and the picker 120 travels the facility to pick the items 108 identified in the primary sequence, in the order specified by the primary sequence. Referring to FIG. 4, an example process by which one or more primary sequences can be generated is illustrated.

The server 130 can, for example, receive a plurality of order records 400, e.g., the six illustrated order records 400-1, 400-2, 400-3, 400-4, 400-5, and 400-6. As will be apparent, the number of order records received for processing at block 305 can vary widely, and may be higher or lower than the six illustrated in FIG. 4. Each order record includes a set of item identifiers, and may also include quantities for each item identifier. For example, the order 400-1 contains three item identifiers (e.g., “aa563b”) and corresponding quantities. The item identifiers can be a stock keeping unit (SKU) identifier, a universal product code (UPC), or the like, and can correspond to identifiers in the repository 148 and to identifiers affixed to or otherwise associated with the items 108 (e.g., disposed on shelf labels adjacent to the corresponding items 108 or the like). The order 400-2, for example, contains five item identifiers, the order 400-3 contains three item identifiers, and so on, as indicated by the patterned or shaded blocks adjacent to each order 400.

To generate one or more primary sequences, the server 130 can be configured to select at least a portion of the orders 400 to be processed for fulfillment. For example, the server 130 can be configured to select a predetermined number of consecutive (in order of receipt timestamp, e.g., indicating when each order 400 was placed) orders. The predetermined number can be stored in the memory 136 as a configuration setting for the application 144. In the example of FIG. 4, the server 130 is configured to select the first three orders 400 (e.g., the three orders 400 with the oldest receipt timestamps). In other examples, the server 130 can be configured to select consecutive orders 400, ordered by time of receipt, until a predetermined number of items are covered by the selected orders 400. The number of orders 400 selected for a given primary sequence may therefore vary based on the number of items 108 (e.g., the number of distinct item identifiers, ignoring quantities) identified in each order 400.

In further examples, the server 130 can select orders 400 for a given primary sequence based on factors such as the locations of the items 108 identified in the orders 400. For example, the server 130 can be configured to select a set of orders 400 (e.g., a predetermined number thereof, or until the selected orders contain a predetermined number of item identifiers) whose items 108 fall within a predetermined area of the facility 100 (e.g., a particular aisle 112 or set of aisles 112). This form of order selection may be omitted if the number of orders 400 to select among is below a threshold, however, as once a portion of the orders have been selected, the remaining orders may have disparate locations and further location-based optimization may not be practical.

In response to selecting at least a portion of the orders 400 for a given primary sequence, the server 130 can then retrieve the locations corresponding to the items 108 identified in the selected orders 400. In the illustrated example, the orders 400 were received in the order shown in FIG. 4, with the order 400-1 having the oldest timestamp, and the order 400-6 having the newest timestamp. The server 130 selects the orders 400-1, 400-2, and 400-3 for a first primary sequence 404-1, and the orders 400-4, 400-5, and 400-6 for a second primary sequence 404-2.

The server 130 then retrieves, e.g., from the repository 148, locations corresponding to each item 108 identified in the selected orders 400 for a primary sequence 404. FIG. 4 illustrates an overhead view of a portion of the facility 100, including aisles 112-0, 112-1, 112-2, 112-3, and 112-4. The locations of the items 108 identified in the orders 400 selected for the primary sequence 404-1 are also illustrated, as retrieved from the repository 148. To generate the primary sequence 404-1, the server 130 is configured to determine a path that traverses each item location once with the minimum total path length, beginning from an initial location such as a pick start area 408 (although the initial location can also be a selected one of the item locations). As will be apparent to those skilled in the art, determining such a path can be performed by implementing any one of a variety of suitable Travelling Salesman Problem (TSP) solutions, e.g., removing the requirement to return to the starting location (which does not alter the computational complexity of the solution). In other examples, determining a path traversing each item in a set of orders 400 can include implementing a Sequential Ordering Problem (SOP) solution, e.g., in which certain sequencing constraints are applied to the items. For example, the server 130 can determine a path that traverses each item while minimizing total path length, and traversing items in a freezer section of the facility 100 at the end of the path (e.g., to pick items 108 from freezers last to reduce the time such items 108 spend outside freezers).

The arrows between item locations in FIG. 4 illustrate an example TSP solution generated by the server 130, in the form of a path traversing each item in the orders 400 of the sequence 404. The primary sequence 404-1 is a set of item identifiers (that is, each item identifier in the orders 400-1, 400-2, and 400-3), ordered according to the illustrated path. Although the sequence 404-1 is illustrated graphically in FIG. 4, it will be understood that the primary sequence 404-1 includes item identifiers, quantities, and locations (e.g., in human-readable form, such as aisle and shelf module identifiers, coordinates to be displayed on a map, or the like).

The above process can be repeated to generate another primary sequence 404-2 from the orders 400-4, 400-5, and 400-6. The performance of block 305 can therefore lead to the generation of at least one, and in some cases a plurality, of primary sequences 404, such that the primary sequences 404 encompass all the orders 400 available to be processed. When more than one primary sequence 404 is generated at block 305, the server 130 can be configured to alternate starting locations. For example, the sequence 404-1 can start at the area 408, while the sequence 404-2 can start at an alternative pick start area, or at an item location in a different region of the facility than the area 408. Generating primary sequences 404 with spaced apart starting locations can reduce congestion in the facility 100, as some primary sequences may be deployed substantially simultaneously to different pickers 120, and the pickers 120 may therefore be less likely to interfere with one another.

Returning to FIG. 3, once the primary sequences 404 are generated, the server 130 can perform the remainder of the method 300 for a given primary sequence 404, and may also initiate other instances of the remainder of the method 300 for other primary sequences 404. The remainder of the method 300, in general, involves generating and deploying auxiliary sequences for robots 128 to assist in the completion of a primary sequence by a picker 120, and deploying the primary sequence to the picker 120. The instances of the remainder of the method 300 can be performed concurrently, e.g., with one instance for each available picker 120 in the facility 100. The performance of one instance of the remainder of the method 300 is described below.

At block 310, the server 130 is configured to select a robot allocation for the primary sequence (e.g., the primary sequence 404-1, in this example). The robot allocation is a number of robots 128 to be assigned to assist a picker 120 in performing the pick operations associated with the primary sequence 404-1, although the allocation need not identify any specific robot 128. The robot allocation selected at block 310 can be predefined, e.g., as configuration data stored in the memory 136. For example, the robot allocation can be predefined as two robots 128 per primary sequence 404, although in other examples, larger numbers of robots 128 can be allocated to each primary sequence 404. In some examples, the robot allocation selected at block 310 is dynamic, e.g., based on the number of orders represented in the primary sequence, and the number of orders each robot 128 can accommodate. For example, each robot 128 may support a range of receptacles 212 (e.g., between one and four). Given that the items 108 for each order 400 are to be collected in one receptacle, the server 130 can determine the size of receptacle 212 required to accommodate each order (e.g., the repository 148 can also contain item sizes), and determine the total pool of receptacles involved in fulfilling the orders of the primary sequence 404-1. From the pool of receptacles, the server 130 can determine a number of robots 128 that provide sufficient capacity for the orders of the primary sequence 404-1.

At block 315, the server 130 is configured to generate a plurality of auxiliary sequences corresponding to the primary sequence 404 (e.g., two auxiliary sequences corresponding to the primary sequence 404-1, in this example). The number of auxiliary sequences generated at block 315 is equal to the robot allocation selected at block 310. While the primary sequence 404 represents a picker tour (e.g., a set of locations to be visited, in a specified order, by a picker 120 to retrieve particular items 108 at those locations), the auxiliary sequences generated at block 315 represent robot tours complementary to the picker tour.

Each auxiliary sequence generated at block 315 (two auxiliary sequences, in this example, as the robot allocation selected at block 310 was two) includes a subset of the item locations from the primary sequence. In combination, the auxiliary sequences traverse each location in the primary sequence, such that at any given location defined by the primary sequence, a robot 128 is available to receive a picked item, and which robot 128 is available alternates at various points throughout the primary sequence.

Generating the auxiliary sequences at block 315 can include dividing the orders 400-1, 400-2, 400-3 of the primary sequence 404-1 between the number of robots selected at block 310. For example, the server 130 can determine whether the number of orders represented in the primary sequence 404-1 can be equally divided among the allocated robots 128. When the determination is negative, such as in the present example where the primary sequence 404-1 represents three orders 400 and the selected robot allocation is two, the server 130 can distribute the orders 400 among the number of allocated robots 128, e.g., assigning the order 400 with the most item identifiers and the order 400 with the least item identifiers to one robot 128, assigning the orders 400 with the second-most and second-least item identifiers to another robot 128, and so on. In further examples, the server 130 can assign orders 400 to robots 128 to balance the total number of items assigned to each robot. Thus, for example, the server 130 can assign the order 400-2 (containing five item identifiers) to one robot 128, and the orders 400-1 and 400-3 (containing a total of six item identifiers) to another robot 128.

When the orders 400 represented by the primary sequence 404 have been divided into a plurality of sets equal in number to the robot allocation from block 310, the server 130 is then configured to generate an auxiliary sequence for each set of orders. Each auxiliary sequence can be generated by retrieving the item locations corresponding to the orders represented by the auxiliary sequence, and generating a TSP and/or SOP solution for the item locations. The server 130 can apply certain constraints to such solutions that are not applied to the generation of the primary sequence(s) 404, such as prohibiting reverse movement in an aisle 112. That is, the robots 128 may be restricted from changing directions once they have entered an aisle 112.

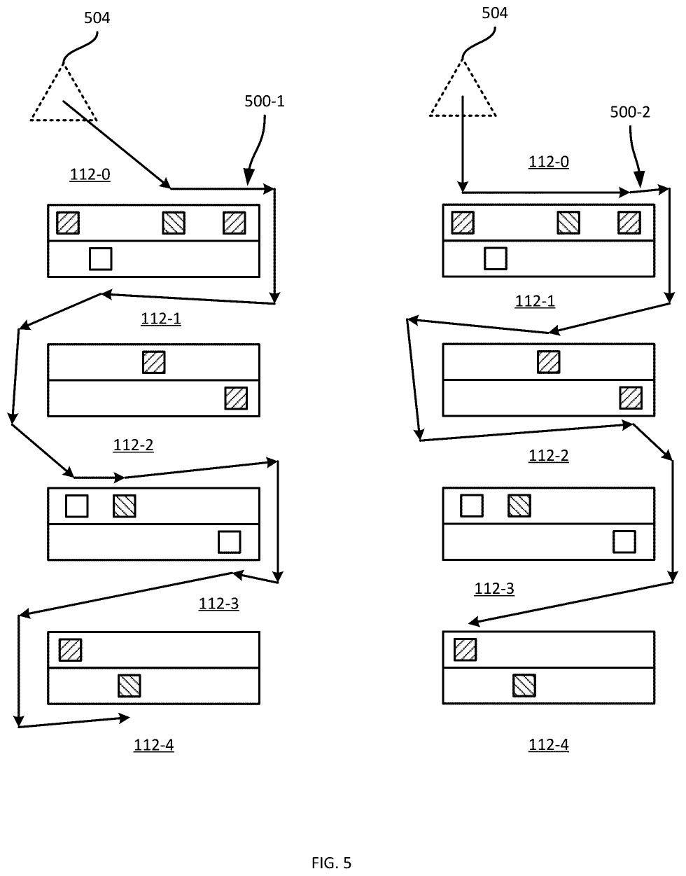

Turning to FIG. 5, two example auxiliary sequences 500-1 and 500-2 are illustrated, resulting from a performance of block 315. The auxiliary sequence 500-1 includes the subset of item identifiers contained in the orders 400-1 and 400-3, while the auxiliary sequence 500-2 includes the subset of item identifiers contained in the order 400-2. As seen from FIG. 5, each auxiliary sequence 500 begins at a robot preparation area 504 or other suitable starting location, e.g., where the robots 128 can be fitted with receptacles 212 or the like. The facility 100 can include more than one starting location in other examples. The auxiliary sequence 500-1 traverses, in an ordered set, the locations of the item identifiers included in the orders 400-1 and 400-3, bypassing the locations of the item identifiers in the order 400-2. The auxiliary sequence 500-2 traverses the locations of the item identifiers included in the order 400-2, bypassing the locations of the item identifiers in the orders 400-1 and 400-3.

Returning to FIG. 3, the server 130 is then configured to deploy the primary sequence 404 and the auxiliary sequences 500. For example, at block 320 the server 130 is configured to send the primary sequence 404-1 to a client device 124, such as the client device 124-1 associated with the picker 120-1. The primary sequence 404-1 can be sent as an ordered list of item identifiers and corresponding locations, for display or other suitable output at the client device 124-1 to guide the picker 120 to each successive location. At block 325, the server 130 is configured to send at least a portion of at least one auxiliary sequence 500 to a corresponding robot 128. In some examples, blocks 320 and 325 can be performed substantially simultaneously. For example, the server 130 can transmit a message to the client device 124-1 containing the primary sequence 404-1, e.g., instructing the picker 120 to travel from the pick start area 408 to the first item location in the primary sequence 404-1. Substantially simultaneously, the server 130 can transmit a message to the robot 128-1 containing at least the first location in the auxiliary sequence 500-2, and a further message to the robot 128-2 containing at least the first location in the auxiliary sequence 500-1. The messages sent to the robots 128 can cause each robot 128 to navigate from the preparation area 504 to the specified locations, concurrently with the picker 120 travelling to the first location in the primary sequence 404-1.

In further examples, the server 130 can be configured to perform at least some instances of block 320 by transmitting a portion of the primary sequence 404-1 to a robot 128, in addition to or instead of a client device 124. For example, the server 130 can be configured to transmit the first entry in the primary sequence 404-1 to the client device 124-1, and the second entry in the primary sequence 404-1 to the robot 128-1. The picker 120-1 may therefore be directed to a first pick via the client device 120-1, and subsequently to a second pick via the display 214 of the robot 128-1 (which has travelled to the location of the first pick). The robots 128 can further include indicator lights or the like (e.g., controllable light strips on the rack 208). At blocks 320 and 325, the server 130 can send, to a corresponding client device 124 and robot 128, a color indicator instructing the robot 128 to illuminate with the specified color, to facilitate the visual identification of a particular robot 128 by a picker 120. Other outputs than colored light can also be employed for this purpose, e.g., audio recordings, text-to-speech, or the like.

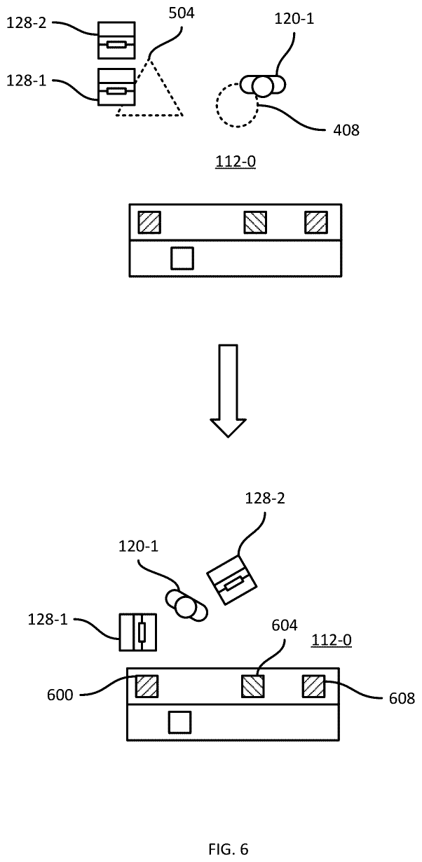

Turning to FIG. 6, for example, from an initial state with the robots 128 at or near the area 504, and the picker 120-1 at or near the area 408, the performance of blocks 320 and 325 can result in the robot 128-1 and the picker 120-1 travelling towards a location 600 (which is the first location in the ordered set defined in the primary sequence 404-1 and the auxiliary sequence 500-2). The robot 128-2, meanwhile, travels towards a location 604 (which is the first location in the auxiliary sequence 500-1, and the second location in the primary sequence 404-1). The robot 128-1 may therefore arrive at the location 600 before, or substantially simultaneously with, the picker 120-1, reducing wait time for the picker 120-1. The robot 128-2 may also arrive at the location 604 before the picker 120-1. As will be apparent, if additional robots 128 are assigned to the primary sequence 404-1, those robots 128 can also be sent to the first locations of their respective auxiliary sequences.

In other examples, the performance of block 325 can vary in time for different robots 128. For example, if five robots 128 are allocated to one primary sequence 404, the server 130 can be configured to delay the transmission of an instruction to a given robot to travel to the next location in the corresponding auxiliary sequence until the relevant picker 120 is within a certain number of steps in the primary sequence (e.g., three or fewer locations away) from the next location for that robot 128.

The server 130 can, in other words, perform more than one instance of block 325 (one per robot 128 allocated at block 310). Each robot 128 can be configured, upon arrival at the relevant location, to present (e.g., on the display 214) an item identifier of the expected item, and an indication of which receptacle 212 the item is to be placed in.

At block 330, the server 130 can be configured to determine whether the next pick specified in the primary sequence 404-1, and therefore the next pick specified in one of the auxiliary sequences 500, is complete. For example, the server 130 can be configured to determine whether an item corresponding to the item location 600 has been picked, indicating completion of the first entry in the primary sequence 404-1, and completion of the first entry in the auxiliary sequence 500-2. The determination at block 330 can include a determination of whether an item with an item identifier matching the first entry in the primary sequence 404-1 has been scanned at the data capture device 216 of the robot 128-1. The determination at block 330, in other words, can be based on one data capture operation, and indicate advancement along two sequences (the primary sequence 404-1, and one of the auxiliary sequences 500). The determination at block 330 is therefore illustrated in two parts, one corresponding to the primary sequence 404-1 and one corresponding to an auxiliary sequence 500. As will be apparent, the server 130 can perform multiple instances of block 330 in parallel, each corresponding to the next entry in an auxiliary sequence and the corresponding entry in the primary sequence.

When the determination is negative, the server 130 waits until an indication of such a scan is received, e.g., from the robot 128-1. When the determination at block 330 is affirmative, the server 130 can determine, at block 335, whether the primary sequence 404-1 is complete. When the primary sequence 404-1 is not complete, the server 130 can transmit the next entry of the primary sequence 404-1 to the client device 124-1, or the client device 124-1 can present the next entry and the server 130 can await the next pick completion at block 330. When the determination at block 335 is affirmative, the server 130 can select a further primary sequence for assignment to the picker 120-1 at block 340. Assignment of a further primary sequence can include, for example, selecting the primary sequence with the initial location closest to the terminal location of the primary sequence 404-1 (e.g., to minimize travel distance by the picker 120-1 between primary sequences). The server 130 then returns to block 320.

The server 130 can also determine, at block 345, in response to an affirmative determination at block 330, whether the auxiliary sequence 500-1 is complete (e.g., whether the entire tour for the robot 128-1 has been completed). When the determination at block 345 is affirmative, at block 350 the server 130 can instruct the robot 128-1 to travel to a pack-out location or other suitable terminal location in the facility. The server 130 then returns to block 325, to deploy another auxiliary sequence (e.g., for a different primary sequence) to the robot 128.

The picker 120-1 and robots 128 thus traverse their respective sequences, e.g., with the picker 120-1 completing a pick at the location 600, and then travelling to the location 604 (where the robot 128-2 has already arrived). Meanwhile, the robot 128-1 travels to a location 608 shown in FIG. 6, while the picker 120-1 performs a pick at the location 604. In other words, the division of orders from the primary sequence 404-1 among multiple robots 128 may permit the robots 128 to arrive at each successive location in the corresponding auxiliary sequence before the picker 120-1 arrives at the same location. The picker 120-1 may therefore be permitted to travel and complete pick operations more quickly than if followed persistently by a single robot 128. The picker 120-1 can also travel throughout the facility without computationally demanding efforts to dynamically reassign pickers 120 to different zones in the facility in response to changing congestion or underutilization of pickers 120.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, the method comprising:
obtaining a primary sequence including an ordered set of item identifiers and item locations corresponding to the item identifiers;
generating a plurality of auxiliary sequences, each auxiliary sequence including a portion of the ordered set of item identifiers and the item locations corresponding to the portion;
deploying the primary sequence to a picker for retrieving, from the item locations, items having the item identifiers; and
for each auxiliary sequence, deploying the auxiliary sequence to a corresponding one of a plurality of robots, each robot configured to receive the items retrieved at the item locations corresponding to the portion.

2. The method of claim 1, wherein obtaining the primary sequence comprises:
obtaining the set of item identifiers and the corresponding item locations; and
generating the primary sequence to minimize a total travel distance between the item locations.

3. The method of claim 2, wherein obtaining the item identifiers includes:
receiving a plurality of order records each containing a respective plurality of item identifiers; and
selecting a portion of the order records.

4. The method of claim 2, wherein obtaining the item identifiers includes: generating a plurality of primary sequences with initial locations in different areas of a facility.

5. The method of claim 1, further comprising, in response to obtaining the primary sequence:
selecting a robot allocation for the primary sequence;
wherein generating the plurality of auxiliary sequences includes generating a number of auxiliary sequences equal to the robot allocation.

6. The method of claim 5, wherein selecting the robot allocation is based on (i) a capacity of each robot, and (ii) a number of the ordered set of item identifiers.

7. The method of claim 1, further comprising:
in response to determining that an auxiliary sequence is complete, controlling the corresponding robot to travel to a terminal location.

8. The method of claim 1, wherein deploying the primary sequence to the picker includes transmitting the primary sequence to a client computing device; and
wherein deploying each auxiliary sequence includes transmitting each auxiliary sequence to a corresponding robot.

9. A computing device, comprising:
a communications interface; and
a processor configured to:
obtain a primary sequence including an ordered set of item identifiers and item locations corresponding to the item identifiers;
generate a plurality of auxiliary sequences, each auxiliary sequence including a portion of the ordered set of item identifiers and the item locations corresponding to the portion;
deploy, via the communications interface, the primary sequence to a picker for retrieving, from the item locations, items having the item identifiers; and
for each auxiliary sequence, deploy, via the communications interface, the auxiliary sequence to a corresponding one of a plurality of robots, each robot configured to receive the items retrieved at the item locations corresponding to the portion.

10. The computing device of claim 9, wherein the processor is configured to obtain the primary sequence by:
obtaining the set of item identifiers and the corresponding item locations; and
generating the primary sequence to minimize a total travel distance between the item locations.

11. The computing device of claim 10, wherein the processor is configured to obtain the item identifiers by:
receiving a plurality of order records each containing a respective plurality of item identifiers; and
selecting a portion of the order records.

12. The computing device of claim 10, wherein the processor is configured to obtain the item identifiers by:
generating a plurality of primary sequences with initial locations in different areas of a facility.

13. The computing device of claim 9, wherein the processor is configured, in response to obtaining the primary sequence, to:
select a robot allocation for the primary sequence; and
generate the plurality of auxiliary sequences by generating a number of auxiliary sequences equal to the robot allocation.

14. The computing device of claim 13, wherein the processor is configured to select the robot allocation based on (i) a capacity of each robot, and (ii) a number of the ordered set of item identifiers.

15. The computing device of claim 9, wherein the processor is configured to:
in response to determining that an auxiliary sequence is complete, control the corresponding robot to travel to a terminal location.

16. The computing device of claim 9, wherein the processor is configured to deploy the primary sequence to the picker by transmitting the primary sequence to a client computing device; and
wherein the processor is configured to deploy each auxiliary sequence by transmitting each auxiliary sequence to a corresponding robot.
